(19) United States
(12) Patent Application Publication
(10) Pub. No.: US 2024/0175761 A1
(43) Pub. Date: May 30, 2024

(54) BLUETOOTH THERMOMETER

(71) Applicant: Zhejiang Shenwei Electric Co., Ltd., Jinhua (CN)

(72) Inventor: LIZHONG CHENG, Jinhua (CN)

(21) Appl. No.: 18/228,804

(22) Filed: Aug. 1, 2023

(30) Foreign Application Priority Data
Nov. 28, 2022 (CN) 202223164731.9

(51) Int. Cl. G01K 1/024; G01K 1/02

(52) U.S. Cl. CPC G01K 1/024; G01K 1/026

(57) ABSTRACT

A Bluetooth thermometer comprises a probe with a hollow structure and a handle arranged at a tail end of the probe, a circuit board is provided inside the probe, and a first temperature sensor for detecting food temperature is provided on the circuit board near a front end of the probe, a capacitor that provides power for the circuit board is electrically connected to a side of the circuit board facing away from the front end of the probe, and the circuit board is also provided with a first Bluetooth module, a tail end of the handle is provided with a metal head, and a conductive wire for charging the capacitor is electrically connected between the metal head and the circuit board. The Bluetooth thermometer has a simple and compact structure, is powered by a capacitor, and can be placed in a high-temperature environment for use.

### CROSS-REFERENCE TO RELATED APPLICATIONS

This is a U. S. patent application which claims the priority and benefit of Chinese Patent Application Number 202223164731. 9, filed on Nov. 28, 2022, the disclosure of which is incorporated herein by reference in its entirety.

### TECHNICAL FIELD

The present application belongs to the technical field of kitchen thermometers, and in particular relates to a Bluetooth thermometer.

### BACKGROUND

When cooking some ingredients, in order to get a better taste, you need to always pay attention to the temperature of the ingredients. For example, when grilling meat, the probe of the thermometer will be inserted into the grilled meat, and then the temperature data will be read through the dial on the probe. However, if a grill or oven is used for grilling meat, if the temperature on the dial needs to be read, the door panel on the grill or oven needs to be opened to read, and such an operation method is relatively cumbersome. For ease of operation, CN207197680U discloses a Bluetooth barbecue thermometer. In this patent, a circuit board and a Bluetooth module are arranged inside the casing, and then the thermometer probe is inserted into the socket on the casing. The circuit board is powered by the dry battery in the casing, which is equivalent to adding an additional Bluetooth module at the end of the traditional thermometer probe, which will result in a larger overall volume and a more complicated structure. At the same time, because the power supply is powered by dry batteries, the Bluetooth barbecue thermometer cannot be used in places with high ambient temperature, such as inside the grill or oven. The temperature in these places can generally reach above 120° C., and if ordinary dry batteries are used in an environment exceeding 50° C., the battery structure may be mechanically damaged, such as sealant asphalt and insulation soften or melt, and even cause battery fluid to leak. Even if you use alkaline zinc-manganese dry batteries with better performance, they are not suitable for use in environments above 60° C.

### SUMMARY

Aiming at the disadvantages above, the present application provides a Bluetooth thermometer, which has a simple and compact structure and is powered by a capacitor, so it can be placed and used in a high temperature environment.

The purpose of the present application is achieved through the following technical solutions: A Bluetooth thermometer, comprises a probe with a hollow structure and a handle arranged at a tail end of the probe, wherein a circuit board is provided inside the probe, and a first temperature sensor for detecting food temperature is provided on the circuit board near a front end of the probe, a capacitor that provides power for the circuit board is electrically connected to a side of the circuit board facing away from the front end of the probe, and the circuit board is also provided with a first Bluetooth module, a tail end of the handle is provided with a metal head, and a conductive wire for charging the capacitor is electrically connected between the metal head and the circuit board.

Preferably, a second temperature sensor for detecting an ambient temperature is also electrically connected to the circuit board, and the second temperature sensor is close to the tail end of the probe.

Preferably, a through hole through the handle is provided on the handle, a stepped surface facing the probe is provided in the through hole, the tail end of the probe is tightly sleeved in the through hole and attached to the stepped surface, and the metal head is arranged at other end of the through hole; the metal head comprises a socket portion and an outer cover portion fixedly connected, the socket portion is tightly inserted into the through hole, the outer cover portion is smoothly transitioned to the tail end of the handle, and a peripheral edge of the outer cover portion is smoothly transitioned to a peripheral edge of the tail end of the handle.

Preferably, the probe is made of stainless steel, and the handle is made of ceramics; a gap is remained between the capacitor and an inner wall of the probe.

Preferably, the probe is a variable-diameter steel tube, the probe comprises a first connecting tube and a second connecting tube fixedly connected coaxially, a front end of the first connecting tube is closed and an outer diameter of the first connecting tube is smaller than an outer diameter of the second connecting tube, and the front end of the first connecting tube is a sharp structure; the circuit board and capacitor are located in the second connecting tube.

Preferably, an insertion depth line is provided on an outer wall of the second connecting tube, and the insertion depth line is located between the first temperature sensor and the second temperature sensor.

Preferably, the conductive wire is a hard conductive metal rod.

Preferably, the conductive wire is a soft wire.

Preferably, the Bluetooth thermometer further comprises a charging stand matched with the metal head, a display screen for displaying temperature data detected by the first temperature sensor and the second temperature sensor, and a second Bluetooth module matched with the first Bluetooth module is arranged on the display screen.

Preferably, the display screen is also provided with a USB interface for power supply, and the charging stand is connected with a USB plug that can be inserted into the USB interface; the charging stand is provided with a conductive terminal electrically connected to the USB plug and matched with the metal head; the charging stand is also provided with a first placement slot for placing the probe and a second placement slot for placing the handle, the conductive terminal is located in the second placement slot, and the charging stand is also provided with a groove communicating with a middle position of the first placement slot, a bottom of the groove is lower than the first placement slot and the groove runs through both sides of the charging stand.

Compared with the prior art, the present application has the following beneficial effects:
1. In the Bluetooth thermometer according to the present application, the circuit board, the first temperature sensor, the capacitor, and the first Bluetooth module are arranged inside the probe, and the overall structure is very compact, which makes the overall structure of the Bluetooth thermometer simpler and smaller;
2. The circuit board is powered by a capacitor, so that the Bluetooth thermometer can be used in a high temperature environment;
3. The temperature data detected by the first temperature sensor can be transmitted wirelessly through the first Bluetooth module, so that the user can read the temperature data through the terminal, which is convenient for use.

### BRIEF DESCRIPTION OF DRAWINGS

FIG. 1 is perspective diagram of the first embodiment;

FIG. 2 is a perspective diagram of an internal structure of the first embodiment;

FIG. 3 is the front diagram of the first embodiment;

FIG. 4 is a sectional diagram at A-A in FIG. 3;

FIG. 5 is a perspective diagram of the charging stand in the first embodiment;

FIG. 6 is a structural schematic diagram of the display screen in the first embodiment;

FIG. 7 is a schematic structural diagram of the probe placed in the charging stand in the first embodiment;

FIG. 8 is a perspective diagram of the second embodiment and the third embodiment;

FIG. 9 is a perspective diagram of an internal structure of the second embodiment and the third embodiment;

FIG. 10 is a front diagram of the second embodiment and the third embodiment;

FIG. 11 is a cross-sectional diagram at B-B in FIG. 10;

FIG. 12 is a perspective diagram of the charging stand in the second embodiment and the third embodiment;

FIG. 13 is a schematic structural diagram of the display screens in the second embodiment and the third embodiment;

FIG. 14 is a structural schematic diagram of the probes in the second embodiment and the third embodiment put into the charging stand;

Reference signs: 1. Probe, 2. Handle, 3. Circuit board, 4. First temperature sensor, 5. Second temperature sensor, 6. Capacitor, 7. First Bluetooth module, 8. Metal head, 9. Conductive wire, 10. Through hole, 11. Stepped surface, 12. First connecting tube, 13. Second connecting tube, 14. Insertion depth line, 15. Charging stand, 16. Display screen, 17. Second Bluetooth module, 18. USB interface, 19. USB plug, 20. Conductive terminal, 21. Groove, 22. First placement slot, 23. Second placement slot, 24. Socket portion, 25. Outer cover portion.

### DETAILED DESCRIPTION

The present application will be further described below in conjunction with the embodiment represented by accompanying drawing:

### First Embodiment

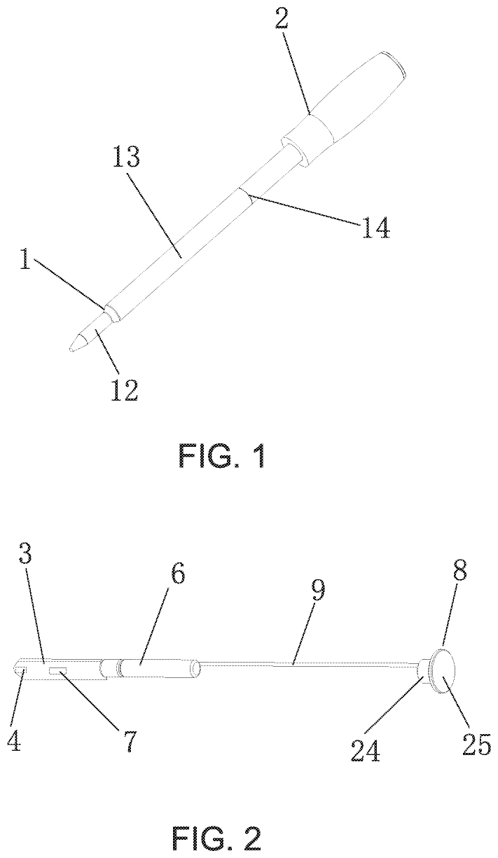

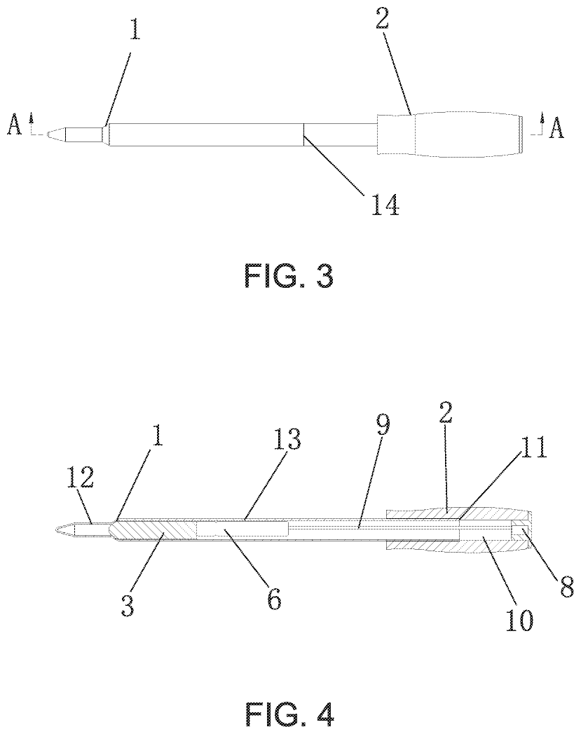

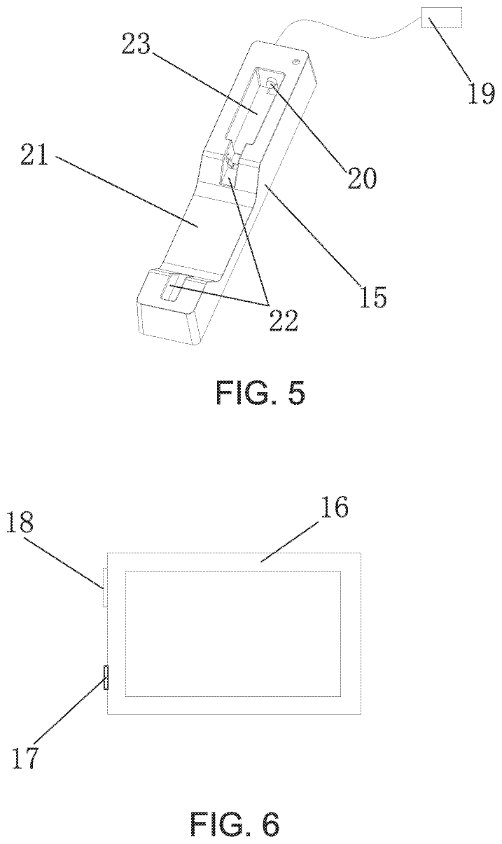

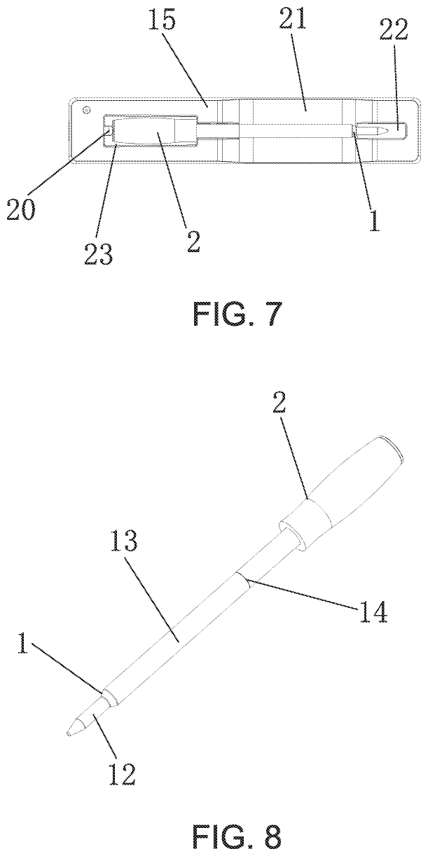

As shown in FIGS. 1-7, a Bluetooth thermometer comprises a probe 1 with a hollow structure and a handle 2 arranged at a tail end of the probe 1. The probe 1 is made of stainless steel, and the handle 2 is made of ceramics. A circuit board 3 is sleeved in the probe 1, and a first temperature sensor 4 for detecting the temperature of food is provided on the circuit board 3 near the front end of the probe 1. A capacitor 6 that provides power for the circuit board 3 is electrically connected to a side of the circuit board 3 facing away from the front end of the probe 1. There is a gap between the capacitor 6 and the inner wall of the probe 1. The capacitor 6 is fixedly connected to the circuit board 3, and the circuit board 3 is also provided with a first Bluetooth module 7 for transmitting wireless signals. The tail end of the handle 2 is provided with a metal head 8, and a conductive wire 9 for charging the capacitor 6 is electrically connected between the metal head 8 and the circuit board 3, and the conductive wire 9 is a hard conductive metal rod. In this embodiment, the circuit board 3 is sleeved in the probe 1 and closely fits with the inner wall of the probe 1, and the conductive wire 9 is made of a hard conductive metal rod, so that the circuit board 3 can be easily pulled out from the probe 1. The handle 2 is provided with a through hole 10 that runs through the handle 2, and the through hole 10 is provided with a stepped surface 11 disposed toward the probe 1, and the tail end of the probe 1 is tightly sleeved in the through hole 10 and attached to the stepped surface 11. The metal head 8 is arranged on the other end of the through hole 10. The metal head 8 comprises a socket portion 24 and an outer cover portion 25 fixedly connected, the socket portion 24 is tightly inserted into the through hole 10, the outer cover portion 25 is smoothly transitioned to the tail end of the handle 2, and a peripheral edge of the outer cover portion 25 is smoothly transitioned to a peripheral edge of the tail end of the handle 2.

The probe 1 is a variable-diameter steel tube, the probe comprises a first connecting tube 12 and a second connecting tube 13 fixedly connected coaxially, a front end of the first connecting tube 12 is closed and an outer diameter of the first connecting tube 12 is smaller than an outer diameter of the second connecting tube 13. The front end of the first connecting tube 12 is a sharp structure; the circuit board 3 and capacitor 6 are located in the second connecting tube 13. An insertion depth line 14 is provided on an outer wall of the second connecting tube 13.

The Bluetooth thermometer further comprises a charging stand 15 matched with the metal head 8, a display screen 16 for displaying temperature data detected by the first temperature sensor 4, and a second Bluetooth module 17 matched with the first Bluetooth module 16 is arranged on the display screen 16. The display screen 16 is also provided with a USB interface 18 for power supply, and the charging stand 15 is connected with a USB plug 19 that can be inserted into the USB interface 18; the charging stand 15 is provided with a conductive terminal 20 electrically connected to the USB plug 19 and matched with the metal head 8.

The charging stand 15 is also provided with a first placement slot 22 for placing the probe 1 and a second placement slot 23 for placing the handle 2, the conductive terminal 20 is located in the second placement slot 23, and the charging stand 15 is also provided with a groove 21 communicating with a middle position of the first placement slot 22, a bottom of the groove 21 is lower than the first placement slot 22 and the groove 21 runs through both sides of the charging stand 15. The display screen 16 is equipped with a power cord, and the power cord is plugged into the power supply for use, and then the USB plug 19 on the charging stand 15 is inserted into the USB interface 18, so that the charging stand 15 is in a power connection state. Insert the probe 1 into the first placement slot 22, and insert the handle 2 into the second placement slot 23. At this time, the metal head 8 contacts the conductive terminal 20 on the charging stand 15, and the capacitor 6 can be charged. By providing the groove 21, it is convenient to pinch the probe 1 and take the probe out from the first placement slot 22.

When using the Bluetooth thermometer, the second Bluetooth module 17 on the display screen 16 can be used to wirelessly connect with the first Bluetooth module 7 in the probe 1, and the temperature data detected by the first temperature sensor 4 can be viewed through the display screen 16, also can use terminal such as mobile phone to carry out wireless connection with first Bluetooth module 7, then use the terminal to read the temperature data obtained by the Bluetooth thermometer. Insert the probe 1 of the Bluetooth thermometer into the grilled meat can detect the internal temperature of the grilled meat through the first temperature sensor 4, and the depth of the probe 1 inserted into the grilled meat cannot exceed the insertion depth line 14.

### Second Embodiment

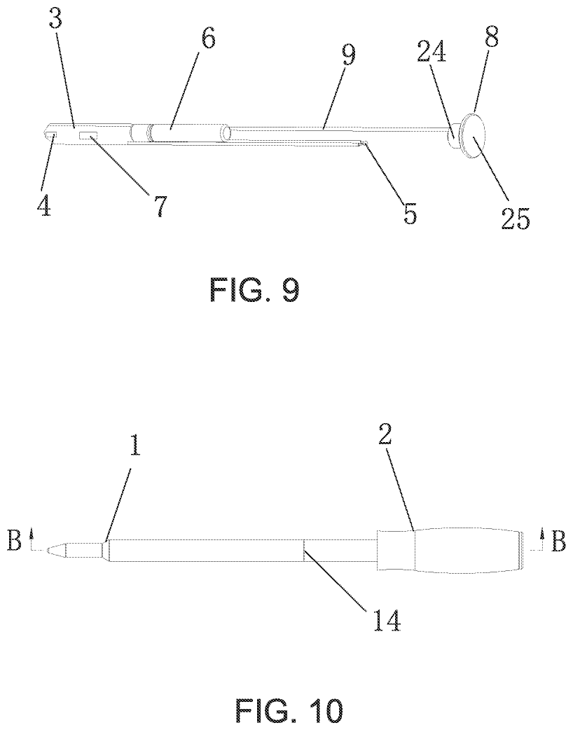

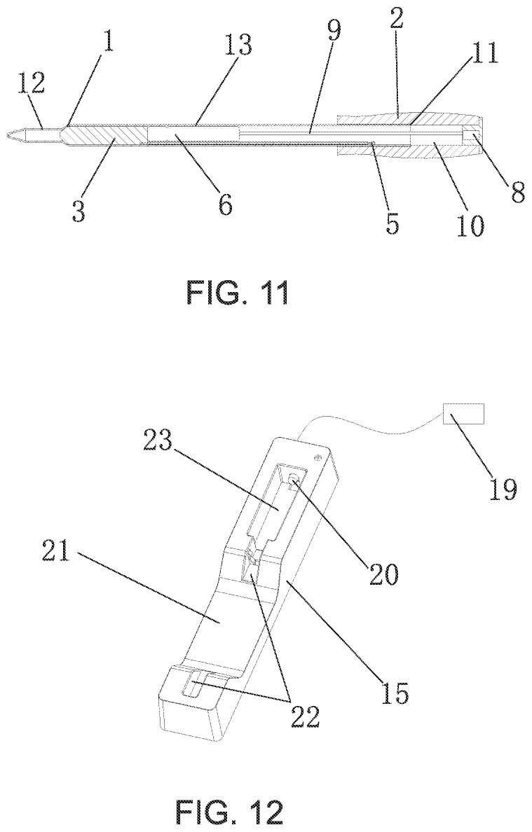

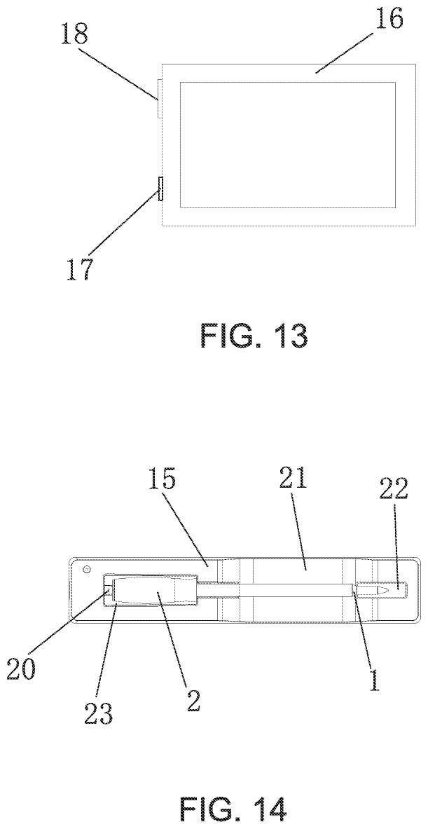

As shown in FIGS. 8-14, a Bluetooth thermometer comprises a probe 1 with a hollow structure and a handle 2 arranged at a tail end of the probe 1. The probe 1 is made of stainless steel, and the handle 2 is made of ceramics. A circuit board 3 is sleeved in the probe 1, and a first temperature sensor 4 for detecting the temperature of food is provided on the circuit board 3 near the front end of the probe 1. A capacitor 6 that provides power for the circuit board 3 is electrically connected to a side of the circuit board 3 facing away from the front end of the probe 1. There is a gap between the capacitor 6 and the inner wall of the probe 1. The capacitor 6 is fixedly connected to the circuit board 3, and the circuit board 3 is also provided with a first Bluetooth module 7 for transmitting wireless signals. The circuit board 3 is also electrically connected with a second temperature sensor 5 for detecting the ambient temperature, and the second temperature sensor 5 is close to the tail end of the probe 1. The tail end of the handle 2 is provided with a metal head 8, and a conductive wire 9 for charging the capacitor 6 is electrically connected between the metal head 8 and the circuit board 3, and the conductive wire 9 is a hard conductive metal rod. In this embodiment, the circuit board 3 is sleeved in the probe 1 and closely fits with the inner wall of the probe 1, and the conductive wire 9 is made of a hard conductive metal rod, so that the circuit board 3 can be easily pulled out from the probe 1. The handle 2 is provided with a through hole 10 that runs through the handle 2, and the through hole 10 is provided with a stepped surface 11 disposed toward the probe 1, and the tail end of the probe 1 is tightly sleeved in the through hole 10 and attached to the stepped surface 11. The metal head 8 is arranged on the other end of the through hole 10. The metal head 8 comprises a socket portion 24 and an outer cover portion 25 fixedly connected, the socket portion 24 is tightly inserted into the through hole 10, the outer cover portion 25 is smoothly transitioned to the tail end of the handle 2, and a peripheral edge of the outer cover portion 25 is smoothly transitioned to a peripheral edge of the tail end of the handle 2.

The probe 1 is a variable-diameter steel tube, the probe comprises a first connecting tube 12 and a second connecting tube 13 fixedly connected coaxially, a front end of the first connecting tube 12 is closed and an outer diameter of the first connecting tube 12 is smaller than an outer diameter of the second connecting tube 13. The front end of the first connecting tube 12 is a sharp structure; the circuit board 3 and capacitor 6 are located in the second connecting tube 13. An insertion depth line 14 is provided on an outer wall of the second connecting tube 13. The insertion depth line 14 is located between the first temperature sensor 4 and the second temperature sensor 5.

The Bluetooth thermometer further comprises a charging stand 15 matched with the metal head 8, a display screen 16 for displaying temperature data detected by the first temperature sensor 4 and the second temperature sensor 5, and a second Bluetooth module 17 matched with the first Bluetooth module 16 is arranged on the display screen 16. The display screen 16 is also provided with a USB interface 18 for power supply, and the charging stand 15 is connected with a USB plug 19 that can be inserted into the USB interface 18; the charging stand 15 is provided with a conductive terminal 20 electrically connected to the USB plug 19 and matched with the metal head 8. The charging stand 15 is also provided with a first placement slot 22 for placing the probe 1 and a second placement slot 23 for placing the handle 2, the conductive terminal 20 is located in the second placement slot 23, and the charging stand 15 is also provided with a groove 21 communicating with a middle position of the first placement slot 22, a bottom of the groove 21 is lower than the first placement slot 22 and the groove 21 runs through both sides of the charging stand 15. The display screen 16 is equipped with a power cord, and the power cord is plugged into the power supply for use, and then the USB plug 19 on the charging stand 15 is inserted into the USB interface 18, so that the charging stand 15 is in a power connection state. Insert the probe 1 into the first placement slot 22, and insert the handle 2 into the second placement slot 23. At this time, the metal head 8 contacts the conductive terminal 20 on the charging stand 15, and the capacitor 6 can be charged. By providing the groove 21, it is convenient to pinch the probe 1 and take the probe out from the first placement slot 22.

When using the Bluetooth thermometer, the second Bluetooth module 17 on the display screen 16 can be used to wirelessly connect with the first Bluetooth module 7 in the probe 1, and the temperature data detected by the first temperature sensor 4 can be viewed through the display screen 16, also can use terminal such as mobile phone to carry out wireless connection with first Bluetooth module 7, then use the terminal to read the temperature data obtained by the Bluetooth thermometer. Insert the probe 1 of the Bluetooth thermometer into the grilled meat can detect the internal temperature of the grilled meat through the first temperature sensor 4, and the depth of the probe 1 inserted into the grilled meat cannot exceed the insertion depth line 14. At this time, the second temperature sensor 5 is located outside the grilled meat, so it can be used to monitor the ambient temperature of the grilled meat, such as the temperature inside the oven.

### Third Embodiment

As shown in FIGS. 8-14, a Bluetooth thermometer comprises a probe 1 with a hollow structure and a handle 2 arranged at a tail end of the probe 1. The probe 1 is made of stainless steel, and the handle 2 is made of ceramics. A circuit board 3 is sleeved in the probe 1, and a first temperature sensor 4 for detecting the temperature of food is provided on the circuit board 3 near the front end of the probe 1. A capacitor 6 that provides power for the circuit board 3 is electrically connected to a side of the circuit board 3 facing away from the front end of the probe 1. There is a gap between the capacitor 6 and the inner wall of the probe 1. The capacitor 6 is fixedly connected to the circuit board 3, and the circuit board 3 is also provided with a first Bluetooth module 7 for transmitting wireless signals. The circuit board 3 is also electrically connected with a second temperature sensor 5 for detecting the ambient temperature, and the second temperature sensor 5 is close to the tail end of the probe 1. The tail end of the handle 2 is provided with a metal head 8, and a conductive wire 9 for charging the capacitor 6 is electrically connected between the metal head 8 and the circuit board 3, and the conductive wire 9 is a soft wire. The handle 2 is provided with a through hole 10 that runs through the handle 2, and the through hole 10 is provided with a stepped surface 11 disposed toward the probe 1, and the tail end of the probe 1 is tightly sleeved in the through hole 10 and attached to the stepped surface 11. The metal head 8 is arranged on the other end of the through hole 10. The metal head 8 comprises a socket portion 24 and an outer cover portion 25 fixedly connected, the socket portion 24 is tightly inserted into the through hole 10, the outer cover portion 25 is smoothly transitioned to the tail end of the handle 2, and a peripheral edge of the outer cover portion 25 is smoothly transitioned to a peripheral edge of the tail end of the handle 2.

The probe 1 is a variable-diameter steel tube, the probe comprises a first connecting tube 12 and a second connecting tube 13 fixedly connected coaxially, a front end of the first connecting tube 12 is closed and an outer diameter of the first connecting tube 12 is smaller than an outer diameter of the second connecting tube 13. The front end of the first connecting tube 12 is a sharp structure; the circuit board 3 and capacitor 6 are located in the second connecting tube 13. An insertion depth line 14 is provided on an outer wall of the second connecting tube 13. The insertion depth line 14 is located between the first temperature sensor 4 and the second temperature sensor 5.

The Bluetooth thermometer further comprises a charging stand 15 matched with the metal head 8, a display screen 16 for displaying temperature data detected by the first temperature sensor 4 and the second temperature sensor 5, and a second Bluetooth module 17 matched with the first Bluetooth module 16 is arranged on the display screen 16. The display screen 16 is also provided with a USB interface 18 for power supply, and the charging stand 15 is connected with a USB plug 19 that can be inserted into the USB interface 18; the charging stand 15 is provided with a conductive terminal 20 electrically connected to the USB plug 19 and matched with the metal head 8. The charging stand 15 is also provided with a first placement slot 22 for placing the probe 1 and a second placement slot 23 for placing the handle 2, the conductive terminal 20 is located in the second placement slot 23, and the charging stand 15 is also provided with a groove 21 communicating with a middle position of the first placement slot 22, a bottom of the groove 21 is lower than the first placement slot 22 and the groove 21 runs through both sides of the charging stand 15. The display screen 16 is equipped with a power cord, and the power cord is plugged into the power supply for use, and then the USB plug 19 on the charging stand 15 is inserted into the USB interface 18, so that the charging stand 15 is in a power connection state. Insert the probe 1 into the first placement slot 22, and insert the handle 2 into the second placement slot 23. At this time, the metal head 8 contacts the conductive terminal 20 on the charging stand 15, and the capacitor 6 can be charged. By providing the groove 21, it is convenient to pinch the probe 1 and take the probe out from the first placement slot 22.

When using the Bluetooth thermometer, the second Bluetooth module 17 on the display screen 16 can be used to wirelessly connect with the first Bluetooth module 7 in the probe 1, and the temperature data detected by the first temperature sensor 4 can be viewed through the display screen 16, also can use terminal such as mobile phone to carry out wireless connection with first Bluetooth module 7, then use the terminal to read the temperature data obtained by the Bluetooth thermometer. Insert the probe 1 of the Bluetooth thermometer into the grilled meat can detect the internal temperature of the grilled meat through the first temperature sensor 4, and the depth of the probe 1 inserted into the grilled meat cannot exceed the insertion depth line 14. At this time, the second temperature sensor 5 is located outside the grilled meat, so it can be used to monitor the ambient temperature of the grilled meat, such as the temperature inside the oven.

It should be understood that in the claims and description of the present application, all “comprising . . . ” should be interpreted as an open meaning, that is, its meaning is equivalent to “contains at least . . . ”, and should not be understood as a closed Meaning, that is, its meaning should not be understood as “contains only . . . ”.

The specific embodiments described herein are only examples to illustrate the spirit of the present application. Those skilled in the art may make various modifications or supplements to the described specific embodiments or replace them in similar ways, but they will not deviate from the spirit of the present application or go beyond the scope defined by the appended claims.

What is claimed is:

1. A Bluetooth thermometer, comprises a probe with a hollow structure and a handle arranged at a tail end of the probe, wherein a circuit board is provided inside the probe, and a first temperature sensor for detecting food temperature is provided on the circuit board near a front end of the probe, a capacitor that provides power for the circuit board is electrically connected to a side of the circuit board facing away from the front end of the probe, and the circuit board is also provided with a first Bluetooth module, a tail end of the handle is provided with a metal head, and a conductive wire for charging the capacitor is electrically connected between the metal head and the circuit board.

2. The Bluetooth thermometer according to claim 1, wherein a second temperature sensor for detecting an ambient temperature is also electrically connected to the circuit board, and the second temperature sensor is close to the tail end of the probe.

3. The Bluetooth thermometer according to claim 1, wherein a through hole through the handle is provided on the handle, a stepped surface facing the probe is provided in the through hole, the tail end of the probe is tightly sleeved in the through hole and attached to the stepped surface, and the metal head is arranged at other end of the through hole; the metal head comprises a socket portion and an outer cover portion fixedly connected, the socket portion is tightly inserted into the through hole, the outer cover portion is smoothly transitioned to the tail end of the handle, and a peripheral edge of the outer cover portion is smoothly transitioned to a peripheral edge of the tail end of the handle.

4. The Bluetooth thermometer according to claim 3, wherein the probe is made of stainless steel, and the handle is made of ceramics; a gap is remained between the capacitor and an inner wall of the probe.

5. The Bluetooth thermometer according to claim 2, wherein the probe is a variable-diameter steel tube, the probe comprises a first connecting tube and a second connecting tube fixedly connected coaxially, a front end of the first connecting tube is closed and an outer diameter of the first connecting tube is smaller than an outer diameter of the second connecting tube, and the front end of the first connecting tube is a sharp structure; the circuit board and capacitor are located in the second connecting tube.

6. The Bluetooth thermometer according to claim 5, wherein an insertion depth line is provided on an outer wall of the second connecting tube, and the insertion depth line is located between the first temperature sensor and the second temperature sensor.

7. The Bluetooth thermometer according to claim 6, wherein the conductive wire is a hard conductive metal rod.

8. The Bluetooth thermometer according to claim 6, wherein the conductive wire is a soft wire.

9. The Bluetooth thermometer according to claim 8, wherein further comprises a charging stand matched with the metal head, a display screen for displaying temperature data detected by the first temperature sensor and the second temperature sensor, and a second Bluetooth module matched with the first Bluetooth module is arranged on the display screen.

10. The Bluetooth thermometer according to claim 9, wherein the display screen is also provided with a USB interface for power supply, and the charging stand is connected with a USB plug that can be inserted into the USB interface; the charging stand is provided with a conductive terminal electrically connected to the USB plug and matched with the metal head; the charging stand is also provided with a first placement slot for placing the probe and a second placement slot for placing the handle, the conductive terminal is located in the second placement slot, and the charging stand is also provided with a groove communicating with a middle position of the first placement slot, a bottom of the groove is lower than the first placement slot and the groove runs through both sides of the charging stand.
